(19) United States
(12) Patent Application Publication
(10) Pub. No.: US 2023/0123303 A1
(43) Pub. Date: Apr. 20, 2023

(54) ADJUSTING RESOURCES WITHIN A HYPERCONVERGED INFRASTRUCTURE SYSTEM BASED ON ENVIRONMENTAL INFORMATION

(71) Applicant: International Business Machines Corporation, Armonk, NY (US)

(72) Inventors: Sandeep Ramesh Patil, Pune (IN); Shajeer K. Mohammed, Bangalore (IN); Vinatha Chaturvedi, Bangalore (IN); Yu-Cheng Hsu, Tucson, AZ (US); Hugh Edward Hockett, Apex, NC (US); Sridhar Muppidi, Austin, TX (US)

(21) Appl. No.: 17/506,494

(22) Filed: Oct. 20, 2021

(51) Int. Cl. G06F 9/50; G06F 21/57; G06F 11/14

(52) U.S. Cl. CPC G06F 9/5055; G06F 9/5077; G06F 9/5038; G06F 21/577; G06F 11/142; G06F 2209/504; G06F 2209/506; G06F 2209/508

(57) ABSTRACT

A computer-implemented method according to one aspect includes identifying environmental information for a hyper-converged infrastructure (HCI) system; and adjusting one or more resources allocated to one or more applications within the HCI system, based on the environmental information.

### BACKGROUND

The present invention relates to resource allocation, and more particularly, this invention relates to dynamically adjusting resource allocation based on environmental factors.

Hyper-converged infrastructure (HCI) systems are a popular way to merge and distribute computing resources to various applications. For example, in a Hyperconverged Infrastructure (HCI) system compute and storage resources are converged into one system and are linked into a single cluster from a storage perspective (e.g., via a clustered filesystem) as well as a compute perspective.

However, currently resource allocations to applications within HCI systems are static and predefined. As a result, when certain events occur, such as the failure of one or more hardware storage devices within an HCI system, or a security compromise of one or more user-side applications within the HCI system, the HCI system may suffer significant performance degradation while the HCI system recovers from such events.

There is therefore a need to improve the reaction of HCI systems to performance-degrading events.

### BRIEF SUMMARY

A computer-implemented method according to one aspect includes identifying environmental information for a hyper-converged infrastructure (HCI) system; and adjusting one or more resources allocated to one or more applications within the HCI system, based on the environmental information.

According to another aspect, in response to determining that the environmental information indicates a need to perform data recovery operations within the HCI system, an amount of resources currently allocated to one or more system-side applications needed to perform the data recovery operations within the HCI system is increased.

In this way, additional merged resources may be allocated to system-side applications that are currently performing data recovery operations within the HCI system. This may minimize a time taken to perform such data recovery operations, which may in turn improve a performance of the HCI system. This allocation of merged resources may also enable these system-side applications to continue managing data storage actions requested by client-side applications while performing data recovery operations, which may also improve the performance of all data storage actions within the HCI system.

According to another aspect, a computer program product includes one or more computer readable storage media, and program instructions collectively stored on the one or more computer readable storage media, where the program instructions include instructions configured to cause one or more processors to perform a method including identifying, by the one or more processors, environmental information for a hyper-converged infrastructure (HCI) system; and adjusting, by the one or more processors, one or more resources allocated to one or more applications within the HCI system, based on the environmental information.

According to another aspect, in response to determining that the environmental information includes an existence of a security threat associated with one or more user-side applications, an amount of merged resources currently allocated to those one or more user-side applications is reduced.

In this way, allocated resources may be reduced for user-side applications that may pose a security threat to the HCI system. This may minimize an amount of negative activity (such as malicious resource usage) that compromised user-side applications are capable of performing within the HCI system, which may improve a performance of the HCI system.

According to another aspect, a system includes a processor; and logic integrated with the processor, executable by the processor, or integrated with and executable by the processor, where the logic is configured to identify environmental information for a hyper-converged infrastructure (HCI) system; and adjust one or more resources allocated to one or more applications within the HCI system, based on the environmental information.

According to another aspect, a computer-implemented method includes identifying one or more hardware storage disk failures within a hyper-converged infrastructure (HCI) system; identifying one or more system-side applications that are needed to perform data recovery operations within the HCI system in response to the one or more hardware storage disk failures; and allocating an additional amount of resources to the identified one or more system-side applications.

According to another aspect, a computer-implemented method includes determining that a user-side application within a hyper-converged infrastructure (HCI) system has an associated risk score that exceeds a predetermined risk threshold; capping an amount of resources allocated to the user-side application at a predetermined resource threshold; and in response to determining that the associated risk score for the user-side application no longer exceeds the predetermined risk threshold, removing the predetermined resource threshold cap for the user-side application.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment in accordance with one aspect of the present invention.

FIG. 2 depicts abstraction model layers in accordance with one aspect of the present invention.

FIG. 3 depicts a cloud computing node in accordance with one aspect of the present invention.

FIG. 4 illustrates a tiered data storage system in accordance with one aspect of the present invention.

FIG. 5 illustrates a flowchart of a method for adjusting resources within a hyper-converged infrastructure system based on environmental information, in accordance with one aspect of the present invention.

FIG. 6 illustrates an exemplary hyper-converged infrastructure (HCI) system environment, in accordance with one aspect of the present invention.

FIG. 7 illustrates a flowchart of a method for dynamically adjusting hyper-converged infrastructure (HCI) system resource allocation during data recovery operations, in accordance with one aspect of the present invention.

FIG. 8 illustrates a flowchart of a method for dynamically capping hyper-converged infrastructure (HCI) system resources in response to a security threat, in accordance with one aspect of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several aspects of adjusting resources within a hyper-converged infrastructure system based on environmental information.

One general aspect includes identifying environmental information for a hyper-converged infrastructure (HCI) system; and adjusting one or more resources allocated to one or more applications within the HCI system, based on the environmental information.

In another general aspect, in response to determining that the environmental information indicates a need to perform data recovery operations within the HCI system, an amount of resources currently allocated to one or more system-side applications needed to perform the data recovery operations within the HCI system is increased.

In this way, additional merged resources may be allocated to system-side applications that are currently performing data recovery operations within the HCI system. This may minimize a time taken to perform such data recovery operations, which may in turn improve a performance of the HCI system. This allocation of merged resources may also enable these system-side applications to continue managing data storage actions requested by client-side applications while performing data recovery operations, which may also improve the performance of all data storage actions within the HCI system.

In another general aspect, a computer program product includes one or more computer readable storage media, and program instructions collectively stored on the one or more computer readable storage media, where the program instructions include instructions configured to cause one or more processors to perform a method including identifying, by the one or more processors, environmental information for a hyper-converged infrastructure (HCI) system; and adjusting, by the one or more processors, one or more resources allocated to one or more applications within the HCI system, based on the environmental information.

In another general aspect, in response to determining that the environmental information includes an existence of a security threat associated with one or more user-side applications, an amount of merged resources currently allocated to those one or more user-side applications is reduced.

In this way, allocated resources may be reduced for user-side applications that may pose a security threat to the HCI system. This may minimize an amount of negative activity (such as malicious resource usage) that compromised user-side applications are capable of performing within the HCI system, which may improve a performance of the HCI system.

In another general aspect, a system includes a processor; and logic integrated with the processor, executable by the processor, or integrated with and executable by the processor, where the logic is configured to identify environmental information for a hyper-converged infrastructure (HCI) system; and adjust one or more resources allocated to one or more applications within the HCI system, based on the environmental information.

In another general aspect, a computer-implemented method includes identifying one or more hardware storage disk failures within a hyper-converged infrastructure (HCI) system; identifying one or more system-side applications that are needed to perform data recovery operations within the HCI system in response to the one or more hardware storage disk failures; and allocating an additional amount of resources to the identified one or more system-side applications.

In another general aspect, a computer-implemented method includes determining that a user-side application within a hyper-converged infrastructure (HCI) system has an associated risk score that exceeds a predetermined risk threshold; capping an amount of resources allocated to the user-side application at a predetermined resource threshold; and in response to determining that the associated risk score for the user-side application no longer exceeds the predetermined risk threshold, removing the predetermined resource threshold cap for the user-side application.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

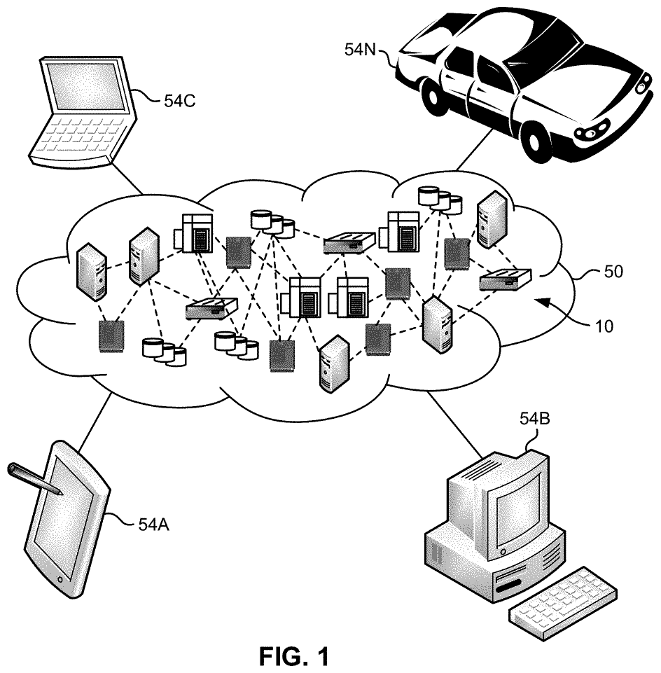

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

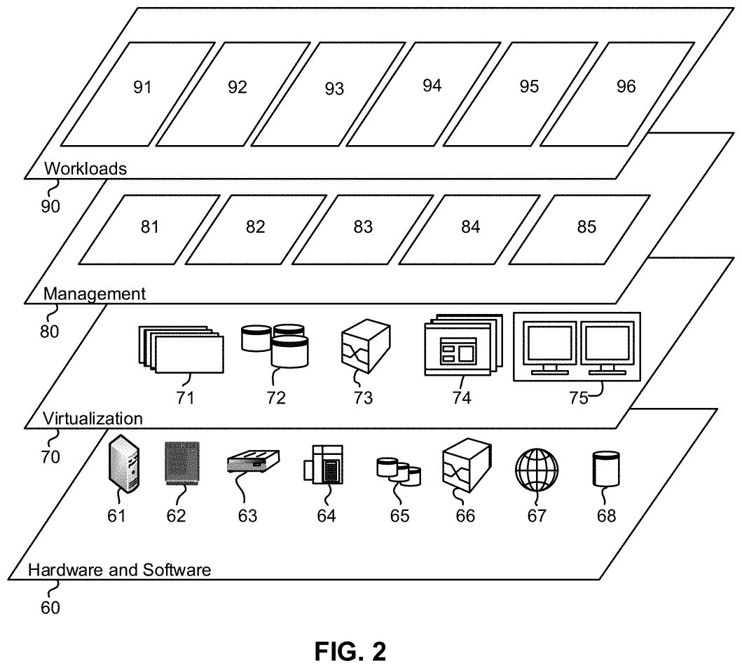

Referring now to FIG. 2, a set of functional abstraction layers provided by cloud computing environment 50 (FIG. 1) is shown. It should be understood in advance that the components, layers, and functions shown in FIG. 2 are intended to be illustrative only and aspects of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some aspects, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and message authentication 96.

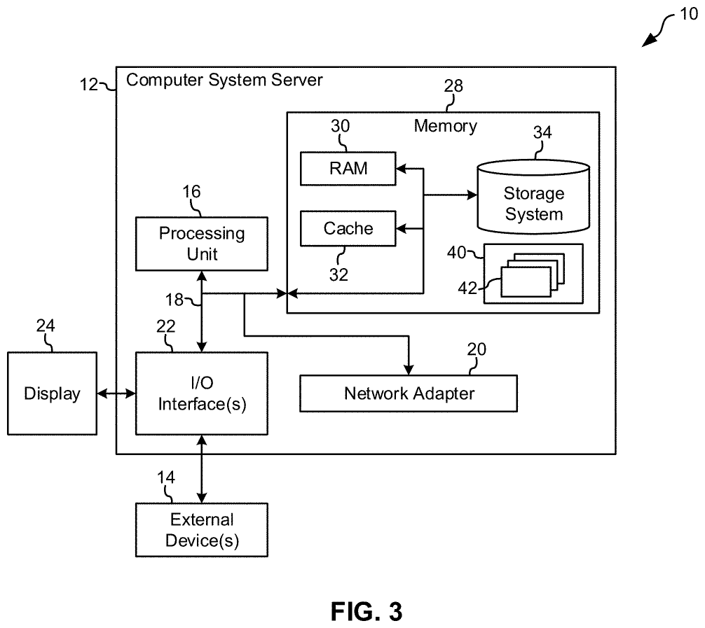

Referring now to FIG. 3, a schematic of an example of a cloud computing node is shown. Cloud computing node 10 is only one example of a suitable cloud computing node and is not intended to suggest any limitation as to the scope of use or functionality of aspects of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of aspects of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of aspects of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

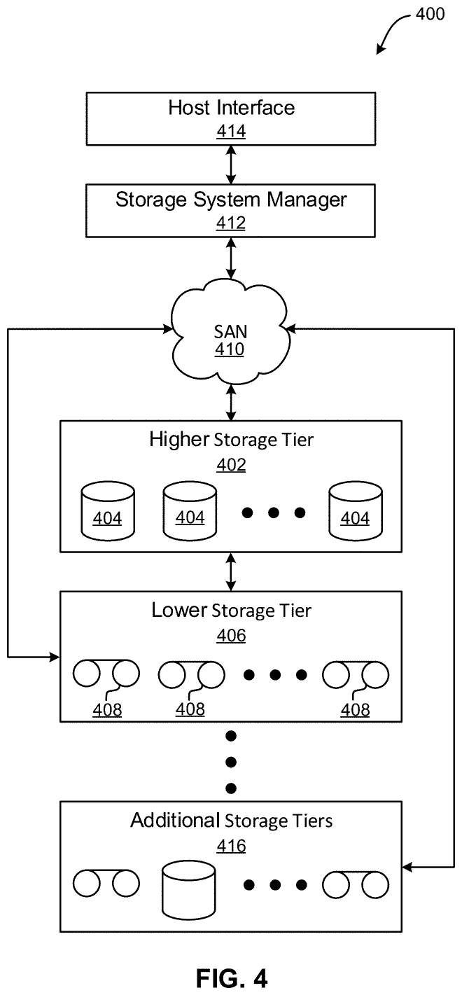

Now referring to FIG. 4, a storage system 400 is shown according to one aspect. Note that some of the elements shown in FIG. 4 may be implemented as hardware and/or software, according to various aspects. The storage system 400 may include a storage system manager 412 for communicating with a plurality of media on at least one higher storage tier 402 and at least one lower storage tier 406. The higher storage tier(s) 402 preferably may include one or more random access and/or direct access media 404, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 406 may preferably include one or more lower performing storage media 408, including sequential access media such as magnetic tape in tape drives and/or optical media, slower accessing HDDs, slower accessing SSDs, etc., and/or others noted herein or known in the art. One or more additional storage tiers 416 may include any combination of storage memory media as desired by a designer of the system 400. Also, any of the higher storage tiers 402 and/or the lower storage tiers 406 may include some combination of storage devices and/or storage media.

The storage system manager 412 may communicate with the storage media 404, 408 on the higher storage tier(s) 402 and lower storage tier(s) 406 through a network 410, such as a storage area network (SAN), as shown in FIG. 4, or some other suitable network type. The storage system manager 412 may also communicate with one or more host systems (not shown) through a host interface 414, which may or may not be a part of the storage system manager 412. The storage system manager 412 and/or any other component of the storage system 400 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more aspects, the storage system 400 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 402, may include a majority of SSD storage media for storing data in a higher performing storage environment, and remaining storage tiers, including lower storage tier 406 and additional storage tiers 416 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 402, while data not having one of these attributes may be stored to the additional storage tiers 416, including lower storage tier 406. Of course, one of skill in the art, upon reading the present descriptions, may devise many other combinations of storage media types to implement into different storage schemes, according to the aspects presented herein.

According to some aspects, the storage system (such as 400) may include logic configured to receive a request to open a data set, logic configured to determine if the requested data set is stored to a lower storage tier 406 of a tiered data storage system 400 in multiple associated portions, logic configured to move each associated portion of the requested data set to a higher storage tier 402 of the tiered data storage system 400, and logic configured to assemble the requested data set on the higher storage tier 402 of the tiered data storage system 400 from the associated portions.

Of course, this logic may be implemented as a method on any device and/or system or as a computer program product, according to various aspects.

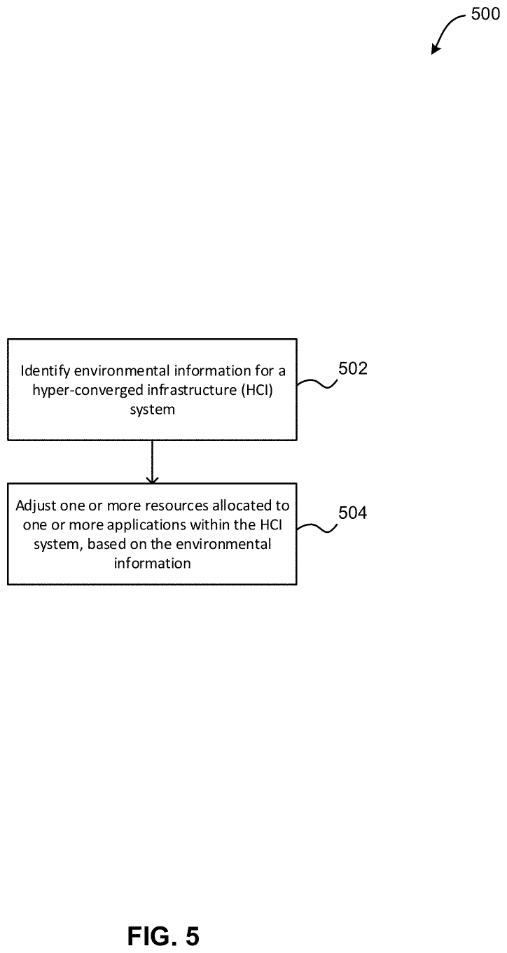

Now referring to FIG. 5, a flowchart of a method 500 is shown according to one aspect. The method 500 may be performed in accordance with the present invention in any of the environments depicted in FIGS. 1-4 and 6, among others, in various aspects. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in various aspects, the method 500 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where environmental information is identified for a hyper-converged infrastructure (HCI) system. In one aspect, hardware resources from a plurality of hardware computing devices (e.g., hardware servers, etc.) and their associated capabilities may be converged/merged to create the HCI system. For example, each of a plurality of hardware computing devices may contain one or more computing resources (e.g., central computing devices (CPUs), graphic computing devices (GPUs), etc.), where each computing resource has associated capabilities (e.g., processor cycles, assignable threads, etc.).

In another example, each of the plurality of hardware computing devices may also contain one or more storage resources (e.g., hard drives, random access memory (RAM), flash memory, etc.), where each storage resource has associated capabilities (e.g., available storage space, etc.). In yet another example, these computing and storage resources may be merged to create a representation (e.g., an HCI system) that contains all computing and storage resources of all of the plurality of hardware computing devices.

Additionally, in one aspect, networking resources and their capabilities may also be converged/merged into the HCI system. For example, the networking resources may include networking hardware such as one or more networking switches, where each networking resource has associated capabilities (e.g., available bandwidth, etc.).

Further, in one aspect, the HCI system may then allocate its merged resources (e.g., computing, storage, memory, and networking resources, etc.) to one or more applications running within the HCI system. In another aspect, the HCI system may allocate a portion of its merged resources to each of the one or more applications running within the HCI system.

For example, the one or more applications may include one or more sub-systems (e.g., one or more containers, etc.). In another example, the one or more applications may include one or more user-side (e.g., client-side) applications that implement one or more user-defined workloads. In yet another example, the one or more applications may include one or more system-side applications that implement one or more system workloads. In still another example, the system-side applications may include embedded software that manage infrastructure within the HCI system.

Further still, in one example, the system-side applications may include one or more storage sub-systems that manage data storage (e.g., data saving, modification, retrieval, etc.) within the HCI. For instance, the data storage managed by the system-side applications may be requested by the client-side applications. In another example, the system-side applications may include one or more computing sub-systems that manage data processing within the HCI. In yet another example, the system-side applications may include one or more management sub-systems that manage data management within the HCI.

Also, in one aspect, the environmental information may include a status of one or more hardware resources within the HCI system. In another aspect, the status of one or more hardware resources may be provided by one or more monitoring elements. For example, disk health monitoring software and/or hardware or one or more storage daemons may determine a health status of one or more hardware storage disks within the HCI system, and may report the health status for each of the one or more hardware storage disks to the HCI system. In another example, the health status may indicate whether each hardware storage disk is running without issue, is experiencing one or more errors, has failed (e.g., is nonresponsive and/or nonfunctional, etc.), etc.

In addition, in one aspect, the environmental information may include an indication of a need to perform data recovery operations within the HCI system, in response to a failure of one or more hardware storage resources or an addition of one or more hardware storage resources within the HCI system. For example, the data recovery operations may include rebuilding one or more hardware resources and/or corresponding merged resources using one or more data recovery techniques (e.g., erasure coding, etc.).

Furthermore, in one aspect, the environmental information may include an indication of system-side applications that are needed to perform the data recovery operations within the HCI system. In another aspect, the environmental information may include details associated with the need to perform data recovery operations within the HCI system. For example, the details may include specific hardware resources and/or corresponding merged resources for which data recovery operations are to be performed.

Further still, in one aspect, the environmental information may include a risk score determined for one or more applications running within the HCI system. In another aspect, the risk score may be provided by one or more monitoring elements. For example, security monitoring software and/or hardware (e.g., a threat detection engine, etc.) may monitor activity within each user-side application running within the HCI system. In yet another aspect, the security monitoring software may intercept and parse data output and input by each application running within the HCI system.

Also, in one aspect, the security monitoring software may track user applications over time and may identify and record historical behavior patterns for the user applications, such as historical data access and network traffic at predetermined times and dates for the user applications. In another aspect, the security monitoring software may identify current behavior patterns for the user applications, such as current data access and network traffic at predetermined times and dates for the user applications.

Additionally, in one aspect, the security monitoring software may identify current behavior patterns for the user applications, such as current data access and network traffic at predetermined times and dates for the user applications. In another aspect, for each of the user applications, the security monitoring software may also compare current behavior patterns for a user application to one or more predetermined threat signatures to determine the risk score for the user application.

Further, method 500 may proceed with operation 504, where one or more resources allocated to one or more applications within the HCI system are adjusted based on the environmental information. In one aspect, adjusting one or more resources allocated to one or more applications within the HCI system may include allocating additional resources to one or more applications within the HCI system.

Further still, in one aspect, in response to determining that the environmental information indicates a need to perform data recovery operations within the HCI system, an amount of resources currently allocated to one or more system-side applications needed to perform the data recovery operations within the HCI system (e.g., one or more of computing, storage, memory, and networking resources, etc.) may be increased.

For example, the one or more system-side applications needed to perform the data recovery operations within the HCI system may be predetermined (e.g., by one or more monitoring elements). In another example, the one or more system-side applications needed to perform the data recovery operations within the HCI system may be determined by analyzing details included within the environmental information (e.g., specific hardware resources and/or corresponding merged resources for which data recovery operations are to be performed) to determine one or more system-side applications needed to perform the data recovery operations.

Also, in another example, within the HCI system, information may be stored identifying specific system-side applications used to perform data recovery operations for specific hardware resources and/or corresponding merged resources. In another example, this information may be compared to specific hardware resources and/or corresponding merged resources for which data recovery operations are to be performed to determine the one or more system-side applications needed to perform the data recovery operations.

In addition, in one aspect, the additional merged resources may be retrieved from a portion of merged resources held in reserve within the HCI system. In another aspect, the additional merged resources may be retrieved from merged resources allocated to other applications within the HCI system. For example, one or more merged resources allocated to one or more additional applications within the HCI system (e.g., one or more client-side applications, system-side applications not performing the data recovery operations within the HCI system, or applications having a lower priority than the applications performing the data recovery operations within the HCI system) may be reduced by a predetermined amount, and that predetermined amount of merged resources may be allocated to the system-side applications performing the data recovery operations within the HCI system.

Furthermore, in one aspect, the environmental information may be updated in response to the allocation of additional resources to the one or more system-side applications performing the data recovery operations within the HCI system. In another aspect, in response to determining that the updated environmental information includes determination that data recovery operations have been completed within the HCI system, the additional merged resources allocated to the one or more system-side applications that performed the data recovery operations within the HCI system may be removed. For example, the removed merged resources may be returned to their former location (e.g., a reserve within the HCI system, other applications within the HCI system, etc.).

In this way, additional merged resources may be allocated to system-side applications that are currently performing data recovery operations within the HCI system. This may minimize a time taken to perform such data recovery operations, which may in turn improve a performance of the HCI system. This allocation of merged resources may also enable these system-side applications to continue managing data storage actions requested by client-side applications while performing data recovery operations, which may also improve the performance of all data storage actions within the HCI system.

Further still, in one aspect, adjusting one or more resources allocated to one or more applications within the HCI system may include allocating fewer resources to one or more applications within the HCI system. In another aspect, in response to determining that the environmental information includes the existence of a security threat associated with one or more user-side applications, an amount of merged resources currently allocated to those one or more user-side applications may be reduced.

Also, in one aspect, a risk score determined for one or more user-side applications running within the HCI system may be compared to a predetermined threshold. In another aspect, in response to determining that the risk score for a user-side application exceeds the predetermined threshold, the user-side application may be identified as risky (e.g., using metadata such as a tag, etc.) and an amount of merged resources currently allocated to the risky user-side application (e.g., one or more of computing, storage, memory, and networking resources, etc.) may be reduced within the HCI system.

For example, a predetermined portion of the merged resources currently allocated to the risky user-side application may be removed. In another example, the removed portion of the merged resources may be allocated to one or more user-side applications (or system-side applications) having a risk score below the predetermined threshold. IN yet another example, an amount of merged resources allocated to the risky user-side application may be capped at a predetermined amount.

Additionally, in one aspect, the environmental information may be updated in response to the reduction of resources to the one or more risky user-side applications having a risk score exceeding the predetermined threshold. In another aspect, in response to determining that a risk score for a risky user-side application no longer exceeds the predetermined threshold, the risky user-side application may no longer be identified as risky, and the removed portion of the merged resources may be returned to the user-side application.

In this way, allocated resources may be reduced for user-side applications that may pose a security threat to the HCI system. This may minimize an amount of negative activity (such as malicious resource usage) that compromised user-side applications are capable of performing within the HCI system, which may improve a performance of the HCI system.

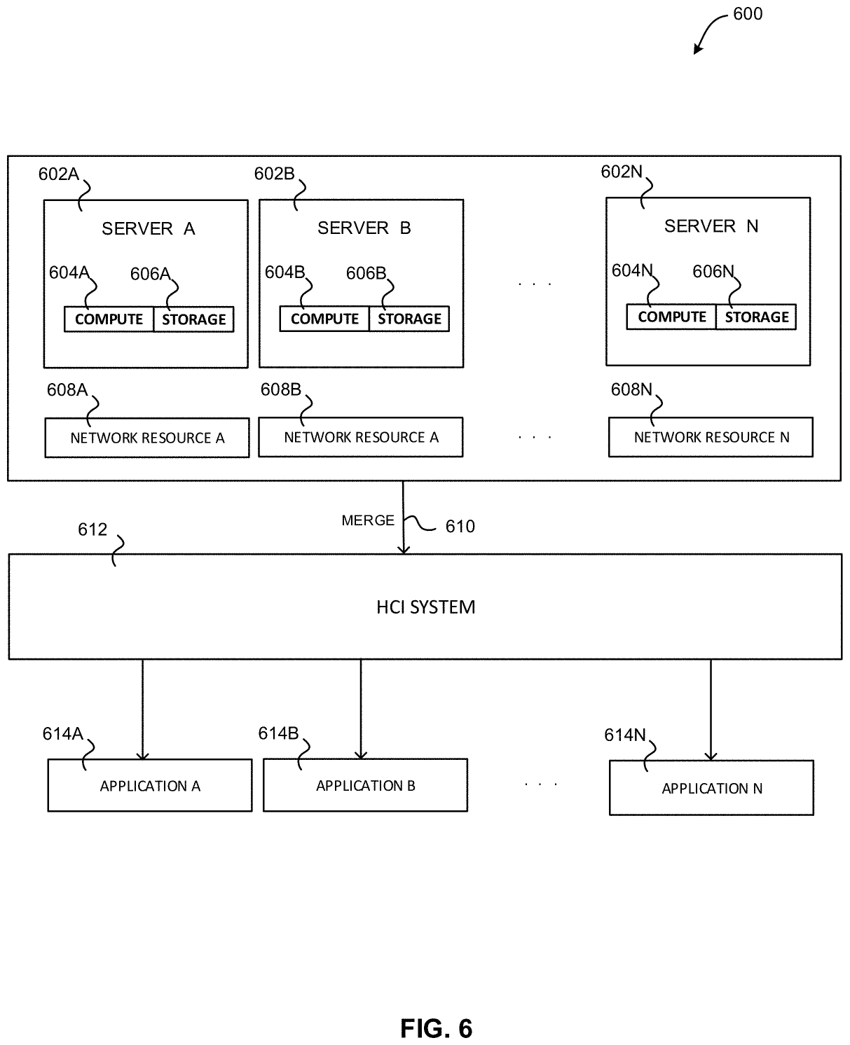

FIG. 6 illustrates an exemplary hyper-converged infrastructure (HCI) system environment 600, according to one exemplary aspect. As shown, a plurality of hardware computing devices 602A-N, each with associated computing resources 604A-N and storage resources 606A-N are merged 610, along with a plurality of networking resources 608A-N, to create an HCI system 612. In this way, the HCI system 612 may include a single abstract representation of its merged resources, which include all the hardware computing devices 602A-N, their associated computing resources 604A-N and storage resources 606A-N, and all networking resources 608A-N.

Additionally, the HCI system 612 may allocate a portion of its merged resources to each of a plurality of applications 614A-N running within the HCI system 612. The plurality of applications 614A-N may include one or more user-side applications, one or more system-side applications, etc.

Further, in one aspect, a need to perform data recovery operations for one or more of the storage resources 606A-N may be determined (e.g., utilizing one or more monitoring elements). In response to determining the need to perform data recovery operations for one or more of the storage resources 606A-N, one or more system-side applications needed to perform the data recovery operations may be identified within the plurality of applications 614A-N. The HCI system 612 may then increase an amount of merged resources allocated to these identified system-side applications, which may minimize a time taken to perform such data recovery operations, and which may in turn improve a performance of the HCI system 612.

Further still, in one aspect, one or more user-side applications having a risk score exceeding a predetermined threshold may be identified within the plurality of applications 614A-N(e.g., utilizing one or more monitoring elements). In response to the identification of these risky user-side applications, the HCI system 612 may reduce an amount of merged resources allocated to these identified risky user-side applications. This may minimize an amount of negative activity that the risky user-side applications are capable of performing within the HCI system 612, which may improve a performance of the HCI system 612.

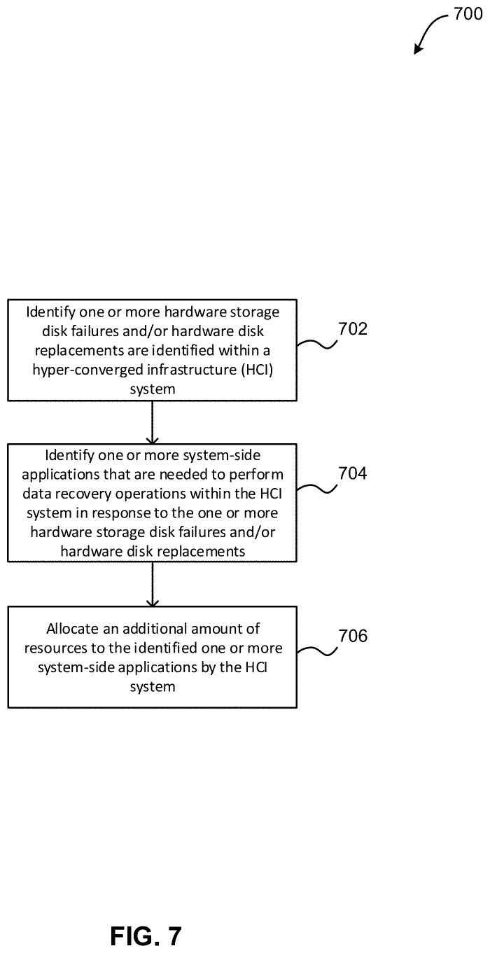

Now referring to FIG. 7, a flowchart of a method 700 for dynamically adjusting hyper-converged infrastructure (HCI) system resource allocation during data recovery operations is shown according to one aspect. The method 700 may be performed in accordance with the present invention in any of the environments depicted in FIGS. 1-4 and 6, among others, in various aspects. Of course, more or less operations than those specifically described in FIG. 7 may be included in method 700, as would be understood by one of skill in the art upon reading the present descriptions.

Each of the steps of the method 700 may be performed by any suitable component of the operating environment. For example, in various aspects, the method 700 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 7, method 700 may initiate with operation 702, where one or more hardware storage disk failures and/or hardware disk replacements are identified within a hyper-converged infrastructure (HCI) system. In one aspect, the failed and/or replaced storage disks may be included as merged resources within the HCI system.

Additionally, method 700 may proceed with operation 704, where one or more system-side applications are identified that are needed to perform data recovery operations within the HCI system in response to the one or more hardware storage disk failures and/or hardware disk replacements. In one aspect, the identified one or more system-side applications may include system-side applications specifically designated to perform data recovery operations for hardware storage disk failures and/or replacements.

Further, method 700 may proceed with operation 706, where an additional amount of resources are allocated to the identified one or more system-side applications by the HCI system. For example, these resources may include merged resources available within the HCI system. Further still, method 700 may proceed with operation 708, where in response to a determination that the data recovery operations have been completed by the identified one or more system-side applications, the additional amount of resources allocated to the identified one or more system-side applications is removed by the HCI system.

In this way, additional resources may be dynamically allocated to system-side applications that are currently performing data recovery operations within the HCI system.

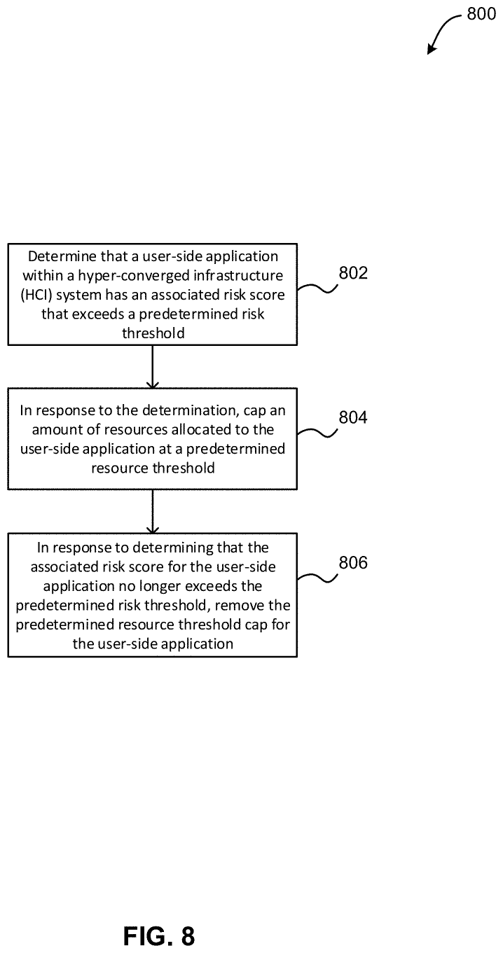

Now referring to FIG. 8, a flowchart of a method 800 for dynamically capping hyper-converged infrastructure (HCI) system resources in response to a security threat is shown according to one aspect. The method 800 may be performed in accordance with the present invention in any of the environments depicted in FIGS. 1-4 and 6, among others, in various aspects. Of course, more or less operations than those specifically described in FIG. 8 may be included in method 800, as would be understood by one of skill in the art upon reading the present descriptions.

Each of the steps of the method 800 may be performed by any suitable component of the operating environment. For example, in various aspects, the method 800 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 800. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 8, method 800 may initiate with operation 802, where a user-side application within a hyper-converged infrastructure (HCI) system is determined to have an associated risk score that exceeds a predetermined risk threshold. Additionally, method 800 may proceed with operation 804, where in response to the determination, an amount of resources allocated to the user-side application may be capped at a predetermined resource threshold. In one aspect, an amount of resources current allocated to the user-side application may be reduced so that the amount does not exceed the predetermined resource threshold.

Further, method 800 may proceed with operation 806, where in response to determining that the associated risk score for the user-side application no longer exceeds the predetermined risk threshold, the predetermined resource threshold cap is removed for the user-side application. In this way, allocated resources may be dynamically reduced for user-side applications that may pose a security threat to the HCI system.

Dynamic Resource Allocation in a Hyper Converged System Based on Threats and Disk Health Functionality

In a Hyperconverged Infrastructure (HCI) system, compute and storage are converged into one system and are linked into a single cluster from a storage point of view (clustered filesystem) as well as from a compute point of view (OCP). Such systems have a defined hardware spec (in form of CPU/Network/RAM) which are shared among the compute sub-system and storage sub-system and the applications (containers).

The allocation of the resources (quota) per sub-system is generally defined by an administrator or by the manufacturer of the HCI system. Such allocations are static in nature and pose unique challenges.

When a disk or disks on an HCI node go down, there is a need for additional resources (e.g., CPU and network resources) at the storage sub-system (e.g., container native storage) running on other nodes which are going to build and continue serving the data that was available on the disk/node that has gone done down. Here the storage sub-system is the container native clustered filesystem implementing data protection using erasure coding across the storage rich server.

In such scenarios, if the static allocation of hardware resources is hard-coded to the storage sub-system containers, it will directly impact their performance and SLA of the containerized application (running on the HCI system) because of storage becoming slow.

There are instances where when a new disk on an HCI node(s) is added (either for upgrade purposes or for replacing a faulted disk(s)), the containers hosting the container native storage where the new disk(s) has been added need additional resource (e.g., CPU and network resources) to be allocated for the storage subsystem until the rebuild is done.

By integrating HCI audit logs other security software, security threat management can report a potential risk score of each of the storage rich server nodes forming the HCI system. When a risk score of a given node goes above the threshold, it is required to lock the resource allocation for container PODs running on that node until the administrator reviews and addresses the risk. A POD may include an abstraction that represents a group of one or more applications (e.g., containers).

In one aspect, a container native HCI specific resource allocation module may dynamically change the allocation of specific hardware resources only for a specific set of storage rich server nodes for containerized storage/compute/application sub-systems based on an ongoing specific situation/scenario.

In one aspect, dynamic resource re-allocation to container native storage subsystem PODs may occur when certain events on the storage rich compute servers occur, such as:
Restriping of data that may trigger when disk(s) go down, nodes(s) go down and/or disk(s) are added or upgraded to the HCI system and container native storage subsystem PODs will need higher CPU and RAM (than usual) until the task is complete.
When a disk's SMART parameters suggest deteriorating health of disks that needs the container native storage subsystem PODs to greedily evaluate the disk data to safer disks.
Regulating resource allocations to containers running on a node of an HCI system, when that node is suspected to have a high risk score as reported by the integrated threat management software. The resource allocation will be capped when the risk score of the node goes above a defined threshold value, and the resource allocation will be reallocated when the risk score of the node goes below the risk threshold value.

The above scenarios are unpredictable and dynamic in nature.

In one aspect, the risk score of a given node may be obtained by threat management software. Risk scores may be tracked at a node level as well as a user level. An HCI system will send all the telemetry of all its nodes/switches/PODs/storage/file access logs, etc. to software which may monitor them for anomalies and generate a risk score per node on the HCI system. The software may also monitor the risk score and if the risk score exceeds a threshold value, the software may send a communication to the HCI system which may trigger resource allocation regulation.

The above functionality may be implemented in a plurality of steps:

Step 1: Allocate static hardware resource allocation for each POD, including container native storage PODs and HCI management PODs using request and limits parameters for a POC/Container spec (as defined in Kubernetes).

Step 2: Have a Policy Enforcement Point (PEP) module for HCI integrate with the resource allocation module of HCI to dynamically change the request, limit & resource quotas for the POD.

Step 3: Catalog the known storage disk/node scenarios where one is expected to dynamically increase the specific hardware resource for specific subsystem (e.g., on specific node(s) for a specific duration or until the scenario/situation is handled). Associate special events to these scenarios.

If one disk on node A has failed then increase the CPU allocation for the storage subsystem (on the other node(s)) by x % but not on the node where the disk is down. If the SMART parameters of the disk are indicating detonation, storage subsystems will need to greedily read and move the data.

If a disk is being up upgraded or replaced, when these events get generated notify the PEP.

Step 4: Have threat detection software and a SIEM solution pull/fetch per-node level time-based telemetry data to analyze anomalies and generate/update a risk score per node. For example, if a node in HCI is noticing a large amount of CPU utilization (which does not match with its heuristic data of the past predetermined number of months), increase the risk count of that node by a predetermined amount.

Step 5: Create a customer script rule that will monitor the risk score for each node in the HCI system and when the score exceeds a defined threshold, it will generate an offense and trigger a special event to a PEP module.

Step 6: When PEP receives an event from Step 3, it will trigger a resource reallocation action for the container native storage PODs based on defined rules. When the PEP receives an event from Step 5, it will trigger a resource capping action for the POD(s) on the node(s) reported to have a higher risk index.

Step 7: Once the observed issue has been resolved, resource allocations are restored to their normal values.

In one aspect, a container native HCI specific resource allocation module may dynamically change an allocation of specific hardware resources only for a specific set of storage rich server nodes for containerized storage/compute/application sub-systems based on an ongoing specific situation/scenario. In another aspect, dynamic resource re-allocation to the container native storage subsystem PODs may be performed when certain events on the storage rich compute servers occur.

Additionally, in one aspect, data restriping may occur, which may be triggered when one or more disks fail, nodes fail, or disks are added or upgraded to the HCI system. In response, container native storage subsystem PODs may be provided with higher CPU and RAM resources until the task is complete.

Further, in one aspect, a disk SMART parameter may suggest a deteriorating health of disks that needs the container native storage subsystem PODs to greedily evaluate the disk data to safer disks. In another aspect, resource allocations to containers running on a node of an HCI system may be regulated when that node is suspected to have a high risk score as reported by integrated threat management software.

Further still, in one aspect, a resource allocation may be capped when the risk score of the node goes above a defined threshold value, and the resource allocation may be reallocated when the risk score of the node goes below the risk threshold value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to aspects of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various aspects may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that aspects of the present invention may be provided in the form of a service deployed on behalf of a customer to offer service on demand.

The descriptions of the various aspects of the present invention have been presented for purposes of illustration, but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects disclosed herein.

What is claimed is:

1. A computer-implemented method, comprising:
identifying environmental information for a hyper-converged infrastructure (HCI) system; and
adjusting one or more resources allocated to one or more applications within the HCI system, based on the environmental information.

2. The computer-implemented method of claim 1, wherein the environmental information includes a status of one or more hardware resources within the HCI system.

3. The computer-implemented method of claim 1, wherein a status of one or more hardware resources within the HCI system is provided by one or more monitoring elements.

4. The computer-implemented method of claim 1, wherein the environmental information includes an indication of a need to perform data recovery operations within the HCI system.

5. The computer-implemented method of claim 1, wherein the environmental information includes an indication of system-side applications that are needed to perform data recovery operations within the HCI system.

6. The computer-implemented method of claim 1, wherein the environmental information includes a risk score determined for one or more applications running within the HCI system.

7. The computer-implemented method of claim 1, wherein adjusting one or more resources allocated to one or more applications within the HCI system includes allocating additional resources to one or more applications within the HCI system.

8. The computer-implemented method of claim 1, wherein in response to determining that the environmental information indicates a need to perform data recovery operations within the HCI system, an amount of resources currently allocated to one or more system-side applications needed to perform the data recovery operations within the HCI system is increased.

9. The computer-implemented method of claim 1, wherein in response to determining that updated environmental information includes determination that data recovery operations have been completed within the HCI system, additional merged resources allocated to one or more system-side applications that performed the data recovery operations within the HCI system are removed.

10. The computer-implemented method of claim 1, wherein in response to determining that the environmental information includes an existence of a security threat associated with one or more user-side applications, an amount of merged resources currently allocated to those one or more user-side applications is reduced.

11. The computer-implemented method of claim 1, wherein in response to determining that a risk score calculated for a user-side application exceeds a predetermined threshold, the user-side application is identified as risky and an amount of merged resources currently allocated to the risky user-side application is reduced within the HCI system.

12. The computer-implemented method of claim 1, wherein in response to determining that a risk score for a risky user-side application no longer exceeds a predetermined threshold, the risky user-side application is no longer identified as risky, and a removed portion of merged resources is returned to the user-side application.

13. A computer program product comprising one or more computer readable storage media, and program instructions collectively stored on the one or more computer readable storage media, the program instructions comprising instructions configured to cause one or more processors to perform a method comprising:
identifying, by the one or more processors, environmental information for a hyper-converged infrastructure (HCI) system; and
adjusting, by the one or more processors, one or more resources allocated to one or more applications within the HCI system, based on the environmental information.

14. The computer program product of claim 13, wherein the environmental information includes a status of one or more hardware resources within the HCI system.

15. The computer program product of claim 13, wherein a status of one or more hardware resources within the HCI system is provided by one or more monitoring elements.

16. The computer program product of claim 13, wherein the environmental information includes an indication of a need to perform data recovery operations within the HCI system.

17. The computer program product of claim 13, wherein the environmental information includes an indication of system-side applications that are needed to perform data recovery operations within the HCI system.

18. The computer program product of claim 13, wherein the environmental information includes a risk score determined for one or more applications running within the HCI system.

19. The computer program product of claim 13, wherein adjusting one or more resources allocated to one or more applications within the HCI system includes allocating additional resources to one or more applications within the HCI system.

20. The computer program product of claim 13, wherein in response to determining that the environmental information indicates a need to perform data recovery operations within the HCI system, an amount of resources currently allocated to one or more system-side applications needed to perform the data recovery operations within the HCI system is increased.

21. The computer program product of claim 13, wherein in response to determining that updated environmental information includes determination that data recovery operations have been completed within the HCI system, additional merged resources allocated to one or more system-side applications that performed the data recovery operations within the HCI system are removed.

22. The computer program product of claim 13, wherein in response to determining that the environmental information includes an existence of a security threat associated with one or more user-side applications, an amount of merged resources currently allocated to those one or more user-side applications is reduced.

23. A system, comprising:
a processor; and
logic integrated with the processor, executable by the processor, or integrated with and executable by the processor, the logic being configured to:
identify environmental information for a hyper-converged infrastructure (HCI) system; and
adjust one or more resources allocated to one or more applications within the HCI system, based on the environmental information.

24. A computer-implemented method, comprising:
identifying one or more hardware storage disk failures within a hyper-converged infrastructure (HCI) system;
identifying one or more system-side applications that are needed to perform data recovery operations within the HCI system in response to the one or more hardware storage disk failures; and
allocating an additional amount of resources to the identified one or more system-side applications.

25. A computer-implemented method, comprising:
determining that a user-side application within a hyper-converged infrastructure (HCI) system has an associated risk score that exceeds a predetermined risk threshold;
capping an amount of resources allocated to the user-side application at a predetermined resource threshold; and
in response to determining that the associated risk score for the user-side application no longer exceeds the predetermined risk threshold, removing the predetermined resource threshold cap for the user-side application.
